(19) United States
(12) Patent Application Publication
(10) Pub. No.: US 2013/0095931 A1
(43) Pub. Date: Apr. 18, 2013

(54) DATA MANAGEMENT FOR COMPUTER SYSTEMS

(71) Applicants: Glenn Fiedler, Santa Monica, CA (US); Vassily A. Filippov, Santa Monica, CA (US); Timothy Moss, Sherman Oaks, CA (US)

(72) Inventors: Glenn Fiedler, Santa Monica, CA (US); Vassily A. Filippov, Santa Monica, CA (US); Timothy Moss, Sherman Oaks, CA (US)

(73) Assignee: Sony Computer Entertainment America LLC, Foster City, CA (US)

(21) Appl. No.: 13/276,261

(22) Filed: Oct. 18, 2011

(51) Int. Cl. G06F 9/46; A63F 9/24

(52) U.S. Cl. 463/43; 718/102

(57) ABSTRACT

A computer system may load into its memory a base WAD corresponding to a logical space associated with a computer application run by a processor. The base WAD contains data uniquely associated with the logical space. Zero or more phases of activity take place in the logical space during running of the application. Phases are uniquely associated with the base WAD. The data in the base-WAD remains loaded for each of the phases. For each phase, the system loads a different set of zero or more sub-WADs into memory. Each phase has a different corresponding set of zero or more sub-wads. Each sub-WAD contains data that is associated with a corresponding phase. The system manages the activity for a given phase using the data in the base WAD and the data in the sets sub-WADs corresponding to the given phase.

### FIELD OF THE INVENTION

Embodiments of the present invention are related to computer systems and more specifically to data management for computer systems.

### BACKGROUND OF THE INVENTION

Video games which allow for multiple users to cooperatively play have proliferated in recent years, and can be found in numerous homes around the world.

Multiplayer games can pit different players directly against each other, such as in a shoot-to-kill game. Multiplayer games can also have players cooperate to achieve a desired goal in the game. Cooperative games can involve players in the same platoon in a war simulation, on the same quest in an adventure series, or pursue other exciting missions.

In designing video games, converting a single player game to a multiplayer cooperative game can be difficult because the single player content, such as levels and missions, are typically budgeted for a single player on a console. That is, one player moving around in each room of the world takes up almost all the entire central processing unit (CPU), memory, and streaming budget. To preserve memory, each room is loaded from memory as the player enters it, and the room just left is unloaded. The room and all its features fill the memory of the console.

In a multiplayer game, multiple players can conceivably explore different rooms or levels at the same time. The tight budgeting for the consoles has been worked around by shipping multiplayer cooperative games with a separate set of CO-OP missions with lesser detail than would be available in a non-CO-OP game. Unfortunately, less detail is undesirable, especially when users are accustomed to a high level of detail in the avatars, non-player characters, interactive objects, background, and other visual and audio items in the video game environment from playing the single-player version. Another workaround for multiplayer games is the use of tethering players.

When players are “tethered” together one player's machine has the data for a given logical space, e.g., a room loaded in memory and that player's machine controls activity taking place in that room. Data for other rooms might not be loaded, however. In such a case other players are limited to being within the same room as the player who has the room data loaded onto his machine. Another player who attempts to move to a different room is halted from proceeding further until player with the room loaded on his machine follows him. Conventionally, tethering the players together preserves memory by forcing the players to move together into each room, so that only one room needs to be loaded and serviced at a time. Thus, the memory and processor budget for the multiplayer game does not significantly exceed that of the single player version of the game. Unfortunately, conventional tethering of players has disadvantages in that one player might want to depart from the confines of the room in which the other player is playing. Thus, solutions for untethering players in a multiplayer game are sought while not requiring an expensive, centralized server for a client-server architecture.

Video games sequences are currently designed such that objects within the game are loaded in packets known as WADs. The term ‘WAD’ is an acronym for “Where's All the Data dataset. A WAD may include data, such as bitmaps, sounds, and features for a given game level. When an in-game character moves from one logical space to another logical space within a sequence of logical spaces within the game, the current WADs are unloaded while the next set of WADs is loaded. Because WADs are inferred via progressing through a level rather than explicitly defined, it is difficult to determine which WADs should be loaded if a player begins in the middle of sequence of events. This makes the testing process of the game more difficult because the tester will have to play the entire sequence through just to test a certain section that may be near the end of the sequence. In a case where a player plays a section of the sequence through, there are difficulties in determining what WADs to build, because there are many different types of WADs that can be permanent or variable.

Level design is further complicated by the lack of a central “parent” WAD that would store overarching variables and scripting that apply to the entirety of the sequence. Currently, complicated edge cases cause scripting to break down. Designers have programmed games to noticeably pause at certain points to allow the system to check whether the right WADs have been loaded. Some objects within games are needed across an entire sequence of events. There currently is no easy way for designers to ensure that the state of such objects will not be reset accidentally. In multiplayer games under the current technology, sets of WADs are loaded separately for each player according to the position of the player. It remains difficult to ensure that the same sets of WADs are loaded for each player.

Under one existing system, known as a level token system, players are allowed to separate and move independently of each other. The level token system is described in commonly-assigned U.S. patent application Ser. No. 12/614,977, filed Nov. 9, 2009, the entire contents of which are incorporated herein by reference. Under this system, players can separate at any period of time, giving the level design considerable freedom. The level token system cannot be used for more structured games that require cooperation among players and separation only at specific junctures. With the current WAD design structure, the video game system of a player that enters a multiplayer game mid-sequence cannot determine what set of WADs should be loaded from this midpoint, because as mentioned above, WADs are inferred from playing through the sequence.

It is within this context that embodiments of the present invention arise.

### BRIEF DESCRIPTION OF THE DRAWINGS

FIG. 1 is a flow diagram illustrating a method for data management in accordance with an embodiment of the present invention.

FIG. 2 illustrates a client-server network architecture implementing an embodiment of the present invention.

FIG. 3 illustrates a peer-to-peer network architecture implementing an embodiment of the present invention.

FIG. 4 illustrates peer-to-peer networked video game consoles in accordance with an embodiment.

FIG. 5 illustrates a video game display with items in various positions and with different settings in accordance with an embodiment.

FIG. 6A illustrates a multiplayer game using a level server and level client in accordance with an embodiment.

FIG. 6B illustrates a subsequent view of the multiplayer game of FIG. 6A.

FIG. 6C illustrates a subsequent view of the multiplayer game of FIG. 6B.

FIG. 7A illustrates a multiplayer game using a level server and level client in accordance with an embodiment.

FIG. 7B illustrates a subsequent view of the multiplayer game of FIG. 7A.

FIG. 7C illustrates a subsequent view of the multiplayer game of FIG. 7B.

FIG. 8A illustrates a multiplayer game using a level server and level client in accordance with an embodiment.

FIG. 8B illustrates a subsequent view of the multiplayer game of FIG. 8A.

FIG. 8C illustrates a subsequent view of the multiplayer game of FIG. 8B. 25

FIG. 8D illustrates a subsequent view of the multiplayer game of FIG. 8C.

FIG. 8E illustrates a subsequent view of the multiplayer game of FIG. 8D.

FIG. 9 illustrates an example computer system suitable for use with embodiments of the invention.

The figures will now be used to illustrate different embodiments in accordance with the invention. The figures are specific examples of embodiments and should not be interpreted as limiting embodiments, but rather illustrate forms and procedures falling within the scope of embodiments of the present invention.

### DESCRIPTION OF THE SPECIFIC EMBODIMENTS

Embodiments of the present invention provide computer software designers ways to alter a given logical space over time, according to scripting, such that new WADs can be loaded for different actions taking place in that logical space, and then unloaded when those actions are concluded. Similarly, this concept can be used to allow the geometry of the logical space to be adjusted over time by loading/unloading WADs corresponding to different parts of the logical space. Thus, for example, if the logical space represented an arena, parts of the arena could be destroyed over time, or new parts of the arena could become accessible.

As used herein the term “logical space” is used to define some portion, or sub-portion, of a virtual environment that is simulated on a computer system or group of computer systems. A “logical space” may be thought of as representing a room, game level, area, section, partition, or other virtual area.

In addition, embodiments of the present invention provide a way for handling scripting in highly linear sequences of action in a given logical space, e.g., a large game level such as the Hades level in God of War 3 (GOW3), or the Poseidon encounter at the start of GOW3. These sequences are highly linear, in that a player traverses from one encounter to a subsequent encounter in a predetermined linear fashion and in doing so that player's machine must load and unload many WADs corresponding to different assets (e.g., data representing pieces of art, enemies, objects, animation, meshes, textures etc) as the player progresses through the logical space.

To implement these two reference cases, among others, embodiments of the present invention make use of a set of data referred to herein as a “base WAD” representing a base “concept” of the logical space, and one or more sub-sets of data (referred to herein as sub-WADs) that are loaded only at certain points during the course of action taking place in that logical space.

Base wads may be thought of as parent WADs. Base WADs are always loaded while a given computer system is in a particular logical space, e.g., a given game level. In the prophetic example of a game level, the base WAD for game level is always loaded while in that level, even though other smaller pieces of the level (sub-WADs), are loaded and unloaded. Base WADs may be regarded as “owning” the sub-WADs. To represent the sub-WAD(s) that are loaded at different stages of action taking place within a given logical space and to provide an easy way to describe different configurations of sub-WADs loaded for the base WAD, the term “phase” is used herein. A phase may be regarded as a particular pre-determined stage of action taking place within a logical space. For each phase has 0 or more “sub-WADs” can be loaded into memory, in addition to the base WAD. All information about which sub-WADs should be loaded for a give phase is statically defined. Thus designers can specify a number of different configurations of the logical space represented by the base WAD. Referring again to the example regarding the Hades level in GOW3, and all that needs to be communicated to a late joining player is to notify that player's machine to load the base WAD corresponding to the relevant level and the sub-WADs for the current phase of action in that level.

Embodiments of the present invention are particularly useful for cases where multiple computer systems access a common logical space, e.g., as in multi-player online games. If a given computer system is a server for a given logical space that system should also be the server for any sub-part of that space. To implement this, the system that acts as the server for a logical space corresponding to a given base WAD is automatically assigned as the server for all sub-WADs associated with the given base WAD. As a result, the system that is the server for a given base WAD is always the server for whatever sub-WADs are associated with the current phase. The only system that can change the phase is the server for the base WAD.

If the sub-WADs are running on a given computer system, the corresponding base WAD is always loaded into that system's memory. This makes the scripting much easier to implement. Global variables associated with the base-WAD can be kept common to all sub-WADs for a give phase. The local variables for a given phase (e.g., whether the setting of a switch is on or off) can be handled by the sub-WAD(s) for that phase. This ensures that when players separate into different logical spaces they will be in the same phase if they reunite in the same logical space. In general, the basewad may contain variables that are globally accessible across the logical space, while sub-WADs may contain variables local to that sub-WAD. Sub-WADs generally do not read variables from other sub-WADs. For example, if a phase 100 needed to know if a lever was pulled in phase 10, a global Boolean variable “LevelPulled” would be put in the base-WAD. If that variable never needed to be accessed (read) outside the sub-WAD then it would be placed in the sub-WAD instead.

In embodiments of the present invention, when a sub-WAD is unloaded, the latest settings for local variables associated with that sub-WAD may be stored or may be re-set to initial values, depending on the relevance of the local variables. For example, in some game modes, such as co-op where players are traversing linear levels, the state of a level may be stored. In other game modes, such as a competitive match in an arena, the phase may be used just to reconfigure the arena space and the previous state of sub-WADs may not be relevant. In such a case, the state of a sub-WAD might not be stored when it is unloaded.

A base WAD may be thought of as a collection of data that defines a given logical space and distinguishes it from other logical spaces within the context of a computer program application, such as a game application. Phase may be thought of as a configuration for the given logical space at different stages of activity occurring in that logical space. For example, in the case of a game program having multiple levels, a different base WAD may be associated with each different level. As phase progresses for that level, the sub-WADs associated with the current phase can be loaded into memory. This avoids inefficient use of memory, e.g., as might result if all the enemies for a given level were loaded in memory at the same time.

In embodiments of the present invention, a given player's machine can have multiple base WADs corresponding to multiple logical spaces loaded into its memory, but the machine is logically only in one such logical space at a time. The machine may be regarded as being “in” a logical space if the scripting in the base WAD for that space determines what happens to the player character associated with that machine. By way of example, there is only one server machine per-base-WAD, but multiple players may be logically “in” the same base WAD. Another way to describe this is that the player may be “owned” by only one base WAD at a time. For example, if a player character dies, scripting in the current base WAD the character is in decides how to re-spawn that player. Phases for a given logical space can be track tracked by multiple machines that are coupled to the machine. Each machine that is in the given logical space has the same phase as the machine that controls the logical space, referred to herein sometimes as the controlling machine and sometimes referred to herein as the “server of the base WAD”. The base WAD is set by the controlling machine. Sub-WADs can be loaded into the memory of machines other than the controlling machine and utilized by those other machines. Such other machines are referred to generally herein as ‘non-controlling machines’ and are sometimes also referred to as ‘clients’ of the base WAD. Non-controlling machines can access the logical space in the sense that they can interact with assets defined by the data in the base WAD and the sub-WADs but the non-controlling machines cannot govern the change of phase for the logical space.

In embodiments of the present invention, it is the controlling machine that exclusively governs the change of the phase and the loading of sub-WADs. If a base WAD for a given logical space is unloaded from the memory of a controlling machine, the program can remember the last state of the base WAD including the phase for that logical space. However, the phase for a logical space cannot be set without loading the corresponding base WAD.

In some embodiments, the command for loading a base WAD can be configured to “request” an initial an initial phase to be loaded with a base WAD. For example, the load command may be configured as Load “BaseWad:10” to requests loading a base WAD in phase 10. Such a capability can be useful when returning to a base WAD that was previously loaded, but where it is desirable to make sure that the base WAD loads in a specific phase. For example, many games include a so-called “hub” level that is returned to multiple times. Such an implementation so that only the server of a base WAD can set the base WAD phase while the level is already loaded. However, if a machine is loading a base WAD (or requesting it to be loaded), that machine can request a phase for the base WAD to be initially loaded in, and if that machine becomes the server of the base WAD as a result of the load, it loads the base WAD in the requested phase, no matter what phase the base WAD was in was when it was last loaded. By default, if a specific phase is not requested upon loading, the base WAD is loaded in the phase the base WAD was in when last loaded.

In embodiments of the invention a game may start by specifying an initial base WAD on a command line, or from a user interface (UI) shell. The scripting for specifying an initial base WAD may include two commands referred to herein as SetPhase and SetLevelWads. The SetPhase command adjusts the phase of the current base WAD. The SetLevelWads can be used to adjust the set of base WADs loaded in memory. These commands may be triggered when one or more players enter into a trigger volume, e.g., when the players reach an intersection between a logical space controlled by base WAD A and another logical space controlled by base WAD B, a command to load both base WAD A and base WAD B into memory could be triggered, then once past a threshold, base WAD A could be dropped from memory entirely.

The controlling machine (e.g., the server of the base WAD) for a given logical space can manage the logical space for itself and other non-controlling machines with which it can communicate, e.g., via computer or telecommunications network. For example, the controlling machine can spawn an AI (game artificial intelligent creature) and direct the AI to attack one of the players. The AI's movements, including the pseudo-random, complex game artificial intelligence algorithms that simulate true artificial intelligence, are seeded or otherwise generated by the controlling machine for the relevant logical space. The level server can handle animations and other features of the game. As discussed above, the controlling machine has the base WAD for the relevant level loaded into its memory along with the sub-WADs for the current phase of activity taking place within that level or other logical space.

The loading of base WADs or sub-WADs can trigger scripts. For example, some embodiments may include a system sometimes referred to as an “entity system”, which defines a bytecode into which designers may include simple expressions. This system can be used e.g., so that when a player enters a volume, a particular expression is run. The expression can have side effects such as setting variables, calling functions, changing world state, or triggering other entities such as animations. Triggering scripts in this context could mean that a trigger volume may be set up such that if the players have moved forward so quickly that they have advanced beyond where it is safe for the scripting in the level, e.g., they are running past the set of WADs loaded, the game can be paused for a “phase check”. This phase check waits for all players in the game to have the correct WADs loaded for the expected phase n, at which point the game un-pauses. Preferably, the game is configured so that this never has to happen. For example, player movement may be slowed down so that it is unlikely for the players to move past the set of WADs loaded. However, even if it is unlikely to be needed, this feature is still a useful fail safe to prevent the game from crashing, and to ensure that the player does not see the level with wads missing etc.

In embodiments of the present invention, a program may implement a load check routine and pause action when moving between logical spaces corresponding to different base WADs. The program can determine which of several machines is to be the controlling machine and command the controlling machine to load the base WAD for a given logical space and/or the sub-WADs for a given phase of activity taking place within that logical space.

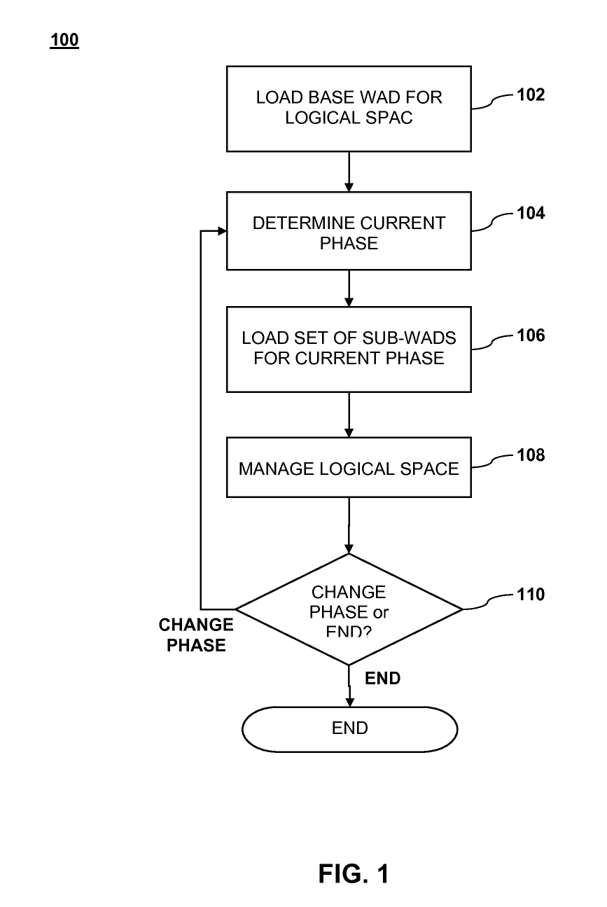

FIG. 1 depicts an example of a method for data management 100 illustrating the concepts of base WADs, phase, and sub-WADs. In accordance with the method 100, a computer system may into its memory a base WAD corresponding to a logical space as indicated at 102. The logical space may be associated with a computer application being run by a processor that is part of the computer system. As discussed above, the base WAD contains a set of data that is uniquely associated with the logical space and there are one or more phases of activity that take place in the logical space during running of the computer application. These phases are uniquely associated with the base WAD and the set of data in the base WAD remains loaded for each of the one or more phases.

Each base WAD or sub WAD has a series of variables. These variables could contain state information such as “leverPulled”, or “numEnemiesKilled”. These variables can be used as state by a simple scripting system (e.g., the entity system), to determine when actions in the game should occur, such as spawning of new enemies, loading new levels, changing phase etc. Typically, the state information in the base WAD would be variables that are “global” across the whole base WAD. For example, if a player pulls a lever in phase 0, that would then later trigger a door to open in phase 100, it would probably be undesirable to have the sub WADs from phase 0 still in memory. Therefore this variable may be in the base WAD so that it is accessible in phase 100 since variables for WADs that are not in memory cannot be accessed. Alternatively, if a player could drag a push block (e.g., a block of granite with a handle on it) across an entire base WAD, the block may be regarded as an “object” that is global to the whole base WAD, and would reside “in” the base WAD, instead of being inside a sub WAD.

The computer system determines the current phase as indicated at 104. By way of example, the base WAD itself need not contain the phase, as the phase of a base WAD must be known even if it is not loaded. Instead the phases for the base WADs may be stored in a global table, [0,maxBaseWads-1], which is initialized to 0 on the host and replicated to all guest machines. When the server of a base WAD sets the phase, it changes this value in the global table and replicates this table to all machines. If a base WAD is unloaded, and reloaded it gets the initial phase from this global table, unless a specific phase is requested in the load, e.g., “BaseWadA:100” loads BaseWadA in phase 100, no matter what the current phase for that base WAD is in the global table prior to load. In such a case, the current phase may be initially determined when the base WAD is loaded. As indicated at 104, the computer system loads different set of one or more sub-WADs into the memory for the current phase. Each sub-WAD contains data that is associated with one or more corresponding phases. Although some sub-WADs may be associated with one or more phases, each phase has associated with it a different corresponding set of one or more sub-wads. In some embodiments, the phases may be empty by default and may therefore have 0 or more sub-WADs per-phase. If sub-WADs are not defined for a phase, then that phase has an empty set of sub-WADs. Another important point is that a sub-WAD may not “belong” to multiple base WADs. Each sub-WAD may have only one unique parent base WAD. This is to avoid conflicts when multiple base WADs are loaded; otherwise a sub-WAD may have two different machines that want to be the server of the sub-WAD. Preventing sub-WADs from “belonging” to multiple base WADs ensures that the server of a base WAD is always the server of the set of sub WADs corresponding to the current phase of the base WAD.

In embodiments of the present invention, for each specific phase of a given base WAD, there is a single statically defined set of sub WADs that may be loaded. In some embodiments, certain sub-WADs are associated with each phase. By way of example, and not by way of limitation, some game levels may include a particular type of sub-WAD, referred to herein as a Skybox, which represents a fixed distant top part of a logical space. A Skybox might contain data for rendering a part of a structure (e.g., a ceiling) or an outdoor vista (e.g., a sky) that does not change throughout the different phases. Other examples are sub-WADs that contain sets of AI enemies to fight, or parts of the level geometry such as textures, meshes, entity scripting etc.

Since the controlling machine for a base WAD controls the phase for all non-controlling machines in that base WAD all players in the same base WAD have the same phase. This avoids conflicts that may occur, e.g., if player characters separate and move into different logical spaces but subsequently rejoin in some common logical space. When the player characters are in different spaces, each space can have a different controlling machine on which the corresponding base WADs and sub-WADs are loaded. The phases for those logical spaces can be individually set by their respective controlling machines. Because phase is a property of a base WAD, whether it is a logical space or physical space, base WADs for different logical spaces can be in completely separate phases. This allows for players to move independently within the set of logical spaces for a given game. Thus, players may have different base WADs loaded on their respective machines, and each of these different base WADs have the same phase across all machines. However, when the players reunite in the same logical space, all the players' machines load the basewad, including non-controlling machines. As will be discussed below, in such a case, players in a common logical space are said to be tethered while they are in that space so that the players' machines do not conflict. Embodiments of the present invention allow players to be tethered while in the same base WAD, and un-tethered only when they are in different base WADs. As such, embodiments of the present invention allow for splitting of player characters to be controlled while still allowing characters to move together.

If all players leave a logical space and later return to it the process of unloading the base WAD and sub-WADs for that logical space may preserve the memory of the last phase for the last player to control that space, e.g., by storing it in the aforementioned global table. However, if desired, entity scripting can override the last phase for a base WAD when it is loaded, no matter what the global table value for the current phase is set to from the last time the wad was loaded.

The following tables list examples of configuration files in YAML format that define a set of base WADs, phases and sub-WADs per-phase associated with a single program. Table I below illustrates an example of a base WAD and sub-WADs per phase for a logical space known as BillieJean.

TABLE II
BillieJean:

0: [BJSky, BJ100, BJ101]
1: [BJSky, BJ100, BJ101, BJ102]
2: [BJSky, BJ101, BJ102, BJ103]
3: [BJSky, BJ102, BJ103, BJ104]
4: [BJSky, BJ103, BJ104, BJ105]
5: [BJSky, BJ104, BJ105, BJ106]
6: [BJSky, BJ105, BJ106, BJ107]
7: [BJSky, BJ106, BJ107, BJ108]
8: [BJSky, BJ107, BJ108, BJ109]
9: [BJSky, BJ108, BJ109]

In the example in Table I above, the base WAD, referred to as BillieJean, has ten phases numbered 0 through 9. In this example, the sub-WADs are BJSky, BJ100, BJ101, BJ102, BJ103, BJ104, BJ105, BJ106, BJ107, BJ108, and BJ109. The quantities inside the square brackets [ ] represent the corresponding set of sub-WADs for each phase. The configurations of sub-WADs per phase can be set as needed by the game designer. In general each phase has a different set of sub-WADs. It is noted that for some phases, it is possible for the set of sub-WADs to be empty, i.e., for there to be no sub-WADs corresponding to that phase. It is further noted that phases need not be consecutively numbered and it is not necessary to define a set of sub-WADs for each of the n phases. For example, omitting a phase is equivalent to that phase existing, but with sub-WADs [ ]. This is important for the designers because they often want to leave gaps between phases, e.g., phase 10, 20, 30, 40—just in case they need to later on squeeze in one or more additional phases between two existing phases, e.g., phase 25 between phases 20 and 30. So by default, a phase may be the empty set of sub-WADs, unless it is declared (e.g., in the YAML) as having a non-empty set of sub-WADs. Furthermore, although the sets of sub-WADs per phase may be different some sub-WADs may be common to two or more phases of the same base WAD. Note that in the example associated with Table II, the sub-WAD BJSky represents a Sky-box that is loaded in all ten phases and each of the other sub-WADs is loaded in two or more successive phases. This particular configuration of sub-WADs per phase is a non-limiting example.

In embodiments of the invention it is possible for a base WAD for a logical space to have only a single phase. Furthermore, it is possible for a base WAD to have no phases at all. This is a degenerate case, but is totally valid—in this case, no matter what phase is set for the base WAD, the only wad loaded is the base WAD.

It is noted that sub-WADs that are used in one phase for a give base WAD may be included in any other subsequent phase. However, there is no requirement that the sets of sub-WADs per phase be different. Although this is probably a good idea it is not enforced. What is enforced however is that a sub-WAD may only be included as a child of one base WAD. For example, as shown in Table V, the sub-WAD SUBHds025 appears in phases 0, 10, 40, 50, and 60 but not in phases 20 or 30.

TABLE IV
SUBHds:

0: [SUBHdsSkyBox, SUBHds025]
10: [SUBHdsSkyBox, SUBHds025, SUBHds100, SUBHds100AI1]
20: [SUBHdsSkyBox, SUBHds100, SUBHds125, SUBHds100AI1]
30: [SUBHdsSkyBox, SUBHds100, SUBHds125]
40: [SUBHdsSkyBox, SUBHds025, SUBHds125]
50: [SUBHdsSkyBox, SUBHds025, SUBHds200]
60: [SUBHdsSkyBox, SUBHds025, SUBHds100]

It is further noted that there is no requirement that each set of sub-WADs have the same number of sub-WADS so long as each set includes zero or more sub-WADs. For example, in the ArenaTest base WAD described in Table V below, each phase has a different number of sub-WADs per phase.

TABLE V
ArenaTest:

1: [ArenaTestSkyBox]
2: [ArenaTestSkyBox, ArenaTestAI1]
3: [ArenaTestSkyBox, ArenaTestAI1, ArenaTestAI2]
4: [ArenaTestSkyBox, ArenaTestAI1, ArenaTestAI2, ArenaTestAI3]

It is further noted that Table V shows an example of a linear progression in which the set sub-WADs for a previous phase is included in the set of sub-WADs for a subsequent phase. Other examples are depicted in Table VI, Table VII, and Table VIII below.

Referring again to FIG. 1, once the sub-WADs have been loaded for a given phase, the computer system manages the activity in the logical space for the current phase as indicated at 108. In managing the activity, the computer system can use the data in the base WAD and the set of sub-WADs for the current phase. Managing the activity in the logical space may include, but is not limited to spawning AI characters, keeping track of the state of AI characters and objects within the logical space, determining when and whether to change the current phase, and determining when to change the set of base WADs in memory, e.g., when to load new base WADs, and/or unload old base WADs. Management of the logical space the computer system can take various forms and is not limited to the embodiments described herein. By way of example, and not by way of limitation, such management can include simple tracking of objects and mediating disputes between level clients. Management can also include broadcasting complex animations, directing AI's throughout the level, and managing the life cycle and network IDs of spawned objects.

The controlling machine is the server of the base WAD. The controlling machine therefore acts as the server, e.g., by arbitrating client requests, broadcasting out decisions made, updating AI, running the entity scripting system, triggering animations and other actions.

By way of example, and not by way of limitation, changes to the current phase may depend on activity taking place during the course activities associated with the logical space. For example, suppose the computer program is a multi-player online computer game and the current phase involves a fight between player characters and an AI enemy. In such a case, a change of phase may be triggered when the computer system determines that the enemy has been defeated.

At 110 the computer system determines whether to change phase or end activity in the logical space. If the computer system determines that the phase should be changed, as indicated at 110, the new phase may be determined at 104 and the process may repeat with the loading of a set of sub-WADs for the new current phase and (optionally) unloading of sub-WADs not needed in the new current phase. It is noted that sub-WADs from a previous phase that are used in the new current phase need not be unloaded and that loading the set of sub-WADs for the new phase may involve only loading sub-WADs that are needed for the new phase that are not yet loaded. It is further noted that state data for any unloaded sub-WADs may be saved so that the state of any assets associated with those sub-WADs (e.g., locations of AI characters or objects) may be quickly restored if the sub-WAD is needed for a subsequent phase or if for some reason activity in the logical space returns to a previous phase.

If it is determined at 110 that activity in the logical space should end then the base WAD and all sub-WADs for the current phase may be unloaded. Information indicating the current phase may be saved along with any state data in the base WAD or any of the sub-WADs for the current phase. The computer system may subsequently load a base WAD for a new logical space and the process may repeat starting from 102.

There are a number of reasons that the computer system may determine that activity in the logical space should end. One non-limiting possibility is that activity for a last phase in a sequence of phases has been completed and subsequently activity takes place in a different logical space, e.g., a different room in a virtual world. Another non-limiting possibility is that a player whose character is controlled by the computer system has moved the character out of the logical space, e.g., by walking the character through a door that leads to a different room. Yet another possibility is that some activity undertaken by a player character triggers the termination, e.g., when a character controlled by the computer system falls through a trap door.

As can be seen from the foregoing discussion, the concept behind embodiments of the invention is relatively simple. There are n base-WADs, where n is an integer greater than or equal to 1. Each base WAD has m phases, where m is an integer greater than or equal to 0. Each phase may have any number of sub-WADs associated with it. Sub-WADs may be shared across multiple phases in the same base WAD, but may not be shared across multiple base WADs.

Embodiments of the invention can work particularly well for networked multiplayer games because all that is needed to communicate the current set of information for a particular logical space at a particular instance in time is to indicate the relevant base WAD and phase for that logical space. In addition, embodiments of the present invention allow different base WADs to be loaded on different machines at the same time, thereby allowing players to split up, but while players are together inside a logical space associated with a given base WAD, they are guaranteed to have the same set of sub-WADs loaded, because each machine follows the phase set by the controlling machine for that base wad.

After a phase is finished the sub-WAD(s) for that phase may be unloaded or may be kept in memory if needed for a subsequent phase depending on the specific implementation. By way of example and not by way of limitation, some embodiments may utilize a concept of a level being “acquired” or “released”. Acquiring a level is a pre-requisite for becoming a client or server in that level. This is described in U.S. patent application Ser. No. 12/614,977, which has been incorporated herein by reference. However, below this acquire/release system there may be a file input/output (I/O) system for WADs. Some embodiments may only evict level WAD data from memory when the space taken up by these WADs is required to load new WADs. So if you had the BilleJean example, and each sub-WAD only took up 1 b, no WADs get evicted once loaded. However, the game and the networking code may consider the WADs, even though still in memory, as “inaccessible”, e.g., state cannot be read from that level WAD, and the values of its variables cannot be read or written. As a practical matter, this is just a caching mechanism for file I/O and does not change the behavior of the WAD loading/unloading.

Embodiments of the invention may be used with multiple computer systems in communication with each other. For example, many computer video games are programmed to be able to be played with one or more players on a single video game console. In some video games, multiple players can connect multiple consoles together through a phone, cable, or other network. Connecting multiple game consoles together can allow the processing power of each game console, which sometimes houses an extraordinarily powerful central microprocessor, graphics rendering and audio processors, and fast memory, to service the processing needs of each player local to the game console while tying game play of all the consoles into one combined game. For enhanced realism and smooth game play, it is often critical for these networked game consoles to work near the envelope of their processing and memory limits.

There are two common types of network architecture for routing packets and other communication signals among networked game consoles: client-server and peer-to-peer.

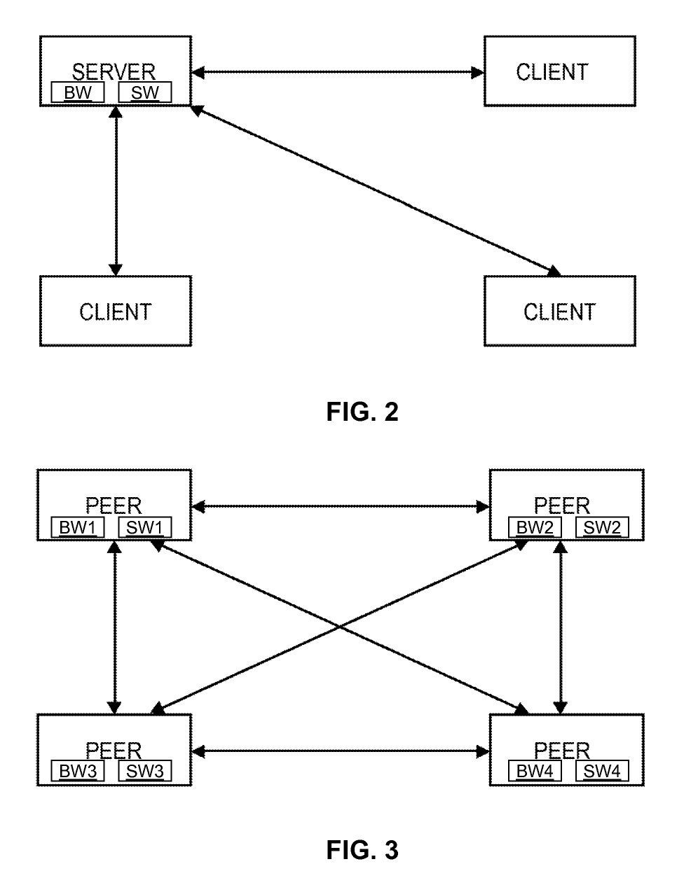

FIG. 2 illustrates a “client-server” network architecture. Communications go between each client and the server, but generally not between clients. In one type of client-server architecture, the client computers are often disparate models (e.g. various personal computers or game consoles) to one another that communicate to a central server or set of servers over a wide area network, such as the Internet. In a video game, the central server tracks the location of each player, non-player character, and various items and objects in the video game. In the client-server architecture, the server may act as the controlling machine for a logical space. As seen in FIG. 1, a base WAD BW and one or more sets of sub-WADS SW are loaded on the server device, which acts as the controlling machine.

In another type of network architecture, the client computers are the same model or relatively similar types (e.g. game consoles) in which one of the clients acts as a server. The server can be selected in an ad hoc fashion between the various connected consoles, and is typically (but not invariably) the console of the first player to begin the game.

FIG. 3 illustrates a “peer-to-peer” network architecture. Communications typically go between each and every peer. Similar or disparate types of computers can be connected with one another in a peer-to-peer topology. In a video game, the peers pass messages and other communications with one another to duplicate the locations of players, non-player characters, objects, and other settings in each peer. In such an architecture, each peer may be the controlling machine for a different logical space, indicated by the different base WADs BW1, BW2, BW3, and BW4 and corresponding sets of sub-WADs SW1, SW2, SW3, and SW4 loaded on different peers.

Embodiments of the present invention allow players to separate to different logical spaces, e.g., different, rooms, levels, etc, and still be in the same phase when they reunite. The process is quite simple, when the two players are in the same logical space, one of the players machine's is the controlling machine (e.g., server or host) for that logical space and has the base WAD and corresponding sub-WADs for that logical space loaded into memory. Non-controlling machines belonging to other players can load the sub-WADs as needed but only the controlling machine can control the change of phase or change of state of any asset in any sub-WAD (e.g., the location of an AI character or whether a lever has been pulled). In this sense, the players can be said to be ‘tethered’ to the phase determined by the controlling machine.

However, when one of the players moves into a different logical space for which there is no controlling machine that player's machine loads the base WAD and sub-WADs for the new logical space into its memory and becomes the controlling machine for that logical space. If there is a controlling machine for the different logical space, each non-controlling machine enters the logical space at the phase determined by the controlling machine. Each controlling machine controls the phase for the logical space for which it has the base WAD loaded. The base wad may be loaded by any machine, even non-controlling machines. The non-controlling machines just do not act as server for the basewad, and may not set the phase. When two players reunite, they are both in the same basewad, and therefore have the same phase and the same set of sub-WADs loaded on both machines—hence, the players are said to be tethered together while in the same logical space.

It is possible for a given machine to be the controlling machine for two different logical spaces at one time. In other words, a machine can have two different base WADs loaded at the same time. In general, any number of base WADs may be loaded onto a given machine limited only by available memory. For example, if two base WADs A and B were loaded onto a machine, the system memory could be divided such that half is used by A, and half by B. Then both base WADs could be loaded on one machine at the same time. Following this, one could have any configuration of base WAD server, e.g., Node 0 could be server of both base WADs, Node 0 could be server of base WAD A, Node 1 server of B, or vice versa.
A more interesting case occurs when the base WADs do not fit into system memory. Consider a four player COOP game played one four machines 0, 1, 2, and 3, and the party decides to split in two where a path branches into left and right forks. In traditional games, the left and right fork must both fit into memory on all machines. However, in embodiments of the present system, the left and right paths could be separate base WADs. The left path base WAD could be loaded on machines 0 and 1 and the right path could be loaded on machines 2 and 3. This allows the left and right base WADs to take up twice the normal memory.

In preferred embodiments, the methods and systems described herein may be used for operating a multiplayer video game on a peer-to-peer network in which game consoles can pass off or accept server or other management responsibilities for individual rooms or other virtual areas from other game consoles. The management responsibilities include such ‘server’ activities as keeping track of the state of a logical space, such as a room or level, spawning and directing AI's (game artificial intelligent creatures), and otherwise managing the room for other consoles which are connected.

While the term “room” is used often herein for purposes of explanation of certain preferred embodiments, it should be understood that any appropriate logical spaces, e.g., a game level, area, section, partition, or other virtual area of a game or other such electronic presentation can be used as well within the scope of the various embodiments.

In a preferred embodiment, the methods described above may include managing a multiplayer video game on game consoles, personal computers, or other machines connected in a peer-to-peer network architecture. Any type of computing devices can be networked together for the game, such as personal computers, game consoles, handheld digital assistants, cellular phones, dedicated handheld game devices, and other electronic game devices.

Management of the logical space can be transferred from one game machine to another. This differs from a centralized server architecture where a single server handles animations, spawns AI's, etc. for the entire game world. Centralized servers of the prior art are not able to distribute the responsibilities of a server across all players in a game on a per-level basis.

Management of a logical space can be automatically transferred in response to one or more of the players who are on the controlling machine that are walking, running, swimming, jumping, flying, teleporting or otherwise moving their avatar or other user-controllable element corresponding to their game machine out of the logical space into another logical space. Moving from one logical space to another can involve, e.g., moving along a corridor, tunnel, escalator, elevator, bridge, or other pathway. There can be a challenge to conquer, such as defeating a foe or solving a puzzle before continuing to another logical space, e.g., room or level. When a given player's machine ceases to act as the level server or host for a given logical space, communications bandwidth, memory space, and processor cycles can be opened up for serving other logical spaces.

Management of a given logical space can also be transferred in response to other factors, such as a degradation in communications with the level clients, taking on an another processing load unrelated to the game, or simply for a round-robin system in which each game console shares level server duties according to a predetermined time schedule. Examples of method for transfer of control over a logical space are described, e.g., in commonly assigned co-pending U.S. patent application Ser. No. 12/614,977 to Glenn Fielder entitled “LEVEL SERVER SYSTEM FOR PEER TO PEER COOPERATIVE GAMES”, filed Nov. 9, 2009, the entire contents of which are incorporated herein by reference.

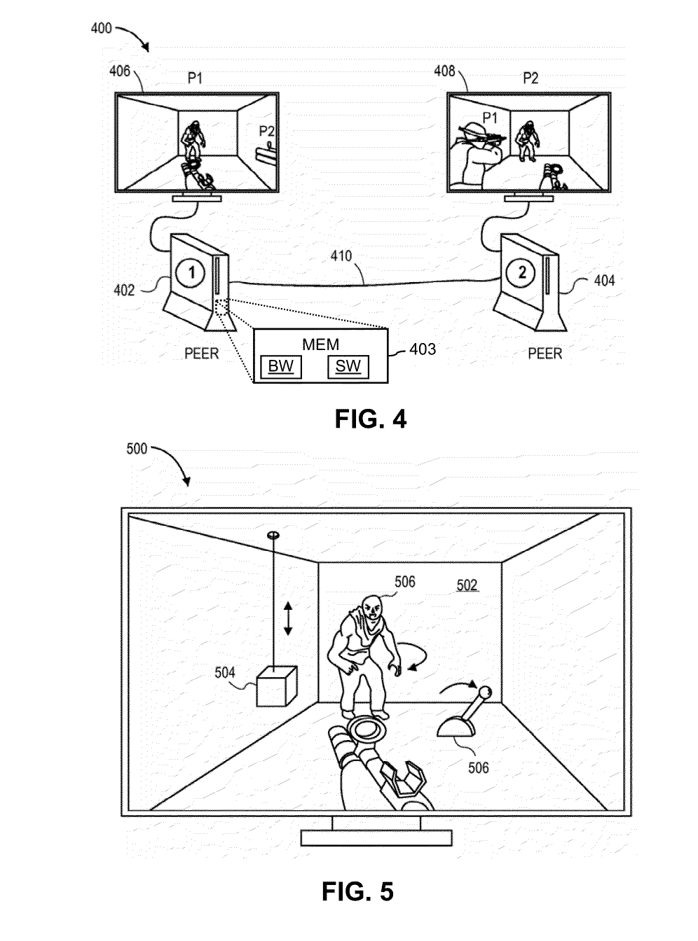

FIG. 4 illustrates peer-to-peer networked video game consoles and their respective displays. Peer-to-peer system 400 includes player P1 game console 402 with P1 display 406, player P2 game console 404 with P2 display 408, and wire connection 410 between the game consoles. As shown on the displays, players P1 and P2 are in the same room.

In this example, game console 402 acts as the controlling machine, and game console 404 is a non-controlling machine. The base WAD BW for the logical space corresponding, e.g., to the relevant game level, is loaded into the memory 403 of game console 402 along with whatever set of sub-WADs SW correspond to the current phase of activity for that game level. By way of example, and not by way of limitation, game console 402 may manage a particular room, tracking the movable objects within the room for both consoles. Game console 402 may control spawning of enemy AI's and direct them to attack the two players. Game console 404 accepts the position of the enemies and follows the action as it occurs on game console 402.

FIG. 5 illustrates a video game display with items in various positions and with different settings in a logical space 502. In this example, the logical space 502 has a movable box 504 that can be moved up or down in response to a pulley system (not shown). A non-player character 506, which can be friendly, neutral, or hostile to the players, is also shown. A lever 508 is also shown. The lever 508 may be manipulated by player characters to shift positions. For example, if a player directs his avatar to walk up to it and the player depresses a button on a controller the position of the lever 508 may be shifted. The controlling machine for the logical space 502 tracks the positions of the various movable objects in the room and/or settings for the objects by manipulating the data in the sub-WAD(s) for each phase of activity within the logical space 502. For example, various positions and settings for the box, non-player character, and lever representing the state of these items at a given instant of time may be included in a sub-WAD for a given phase of the base WAD for the logical space 5021 as shown in Table IX below.

TABLE IX

| Item | Setting |
|---|---|
| Box | position.z = 0.1865233 |
| Non-player character | spawned = true |
| | position.x = 10.536641 |
| | position.y = −3.4277712 |
| | position.z = 0.0000000 |
| | leftelbow.angle = . . . |
| | . |
| | . |
| | . |
| | velocity.x = 0.2113988 |
| | . |
| | . |
| | . |
| | weapon = false |
| Lever | pulled = true |

The tracked information in the sub-WADs can be kept by the controlling machine until needed by a non-controlling machine, or the information can be disseminated at regular intervals to the non-controlling machines.

In example illustrated in FIG. 5, when a player walks up to the lever and depresses a gamepad button, a signal is sent to the level server to toggle the lever. The level server can determine whether the user has performed prerequisites to move the lever, such as moving other levers in other rooms, obtaining a key to unlock the lever, or acquiring strength. Once the level server has determined that the player can move the lever, the lever is animated such that it moves from one position to another. The animation can be handled by the level server, or the level server can direct the level client to perform the final rendered animation such that the lever appears to move on the player's display. Other players who are in the room, if they are looking in the direction of the lever, can also see the lever move if their consoles, level clients, receive the animation from the level server. If two players attempt to handle the lever, one trying to move it and the other trying to hold it in position, the level server can mediate whether the lever moves. For example, the first player to the lever according to the level server can be determined to be the player who ultimately commands the lever.

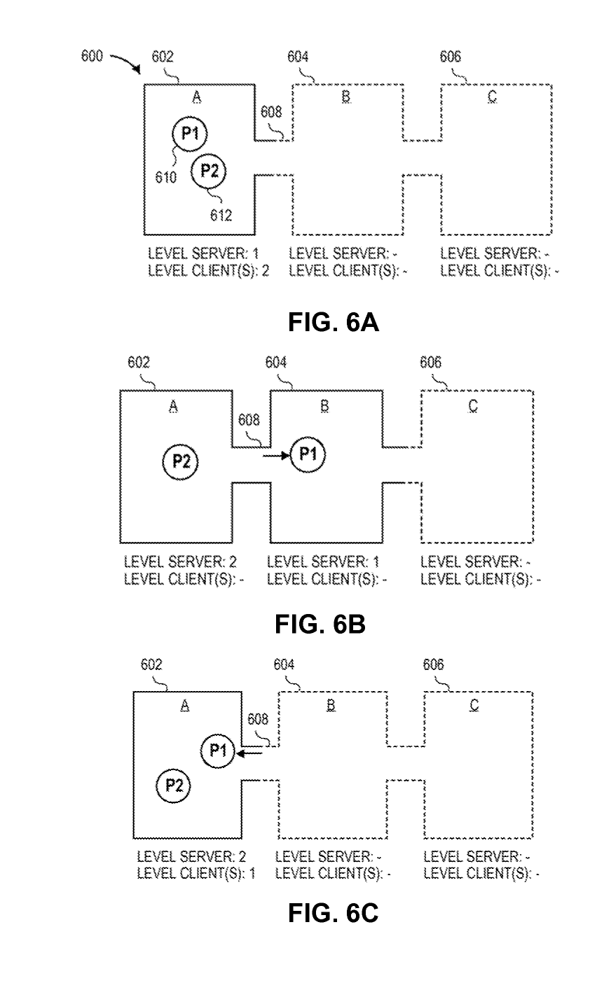

FIGS. 6A-6C illustrate an example of an embodiment of the present invention in which a multiplayer game uses one machine as a level server (or host) and a different machine as a level client (or peer). Three logical spaces (e.g., rooms, or levels) are shown. Solid lines indicate logical spaces for which the relevant base WAD and sub-WADs are loaded in one of the console's memories, and dashed lines indicate logical spaces for which no base WAD or sub-WADs are loaded in any consoles memories. A first logical space 602, is herein referred to as level A, a second logical space room 604 is referred to as level B, and a third logical space 606 is referred to as level C. The different levels are connected by corridors, such as corridor 608. Player 610 is referred to as player P1, and player 612 is referred to as player P2. In this embodiment, each peer-to-peer connected console can hold only one room in memory.

By having players move through a corridor between different levels, the game program allows a transition time for level server transitions, loading and unloading of base WADs and sub-WADs for levels, and a slight break for the player to become ready for the next level.

Below each room in the figures is a key which indicates which game console machine is the controlling machine (e.g. level server or host) and which machines is not a controlling machine (e.g., a level client or peer). Each level can have its own level server and one or more level clients. In this example, there are two game consoles.

In FIG. 6A, players P1 and P2 both start out in level A. As the key for level A indicates, P1's console, console 1, acts as the controlling machine for level A. The base WAD for level A is loaded on console 1, which can be console 402 (see FIG. 4). Console 1 determines the phase for level 1 and spawns and directs the non-player characters such as non-player character 506 (see FIG. 5), tracks the movable objects, and otherwise manages the different phases of level A. Console 2, which can be console 404 (see FIG. 4), accepts the non-player characters spawned and directed by console 1. Console 2 does not manage level A but leaves the management, level server tasks to console 1. Console 2 can load only the sub-WADs for the current phase of level A as determined by console 1.

In FIG. 6B, player P1 walks from level A to level B. In response to the player walking out of level A, server responsibilities for level A transfer from console 1 to console 2. Specifically, console 1 may unload the base WAD for level A along with the sub-WADs that were loaded for the current phase. Console 2 may then load the base WAD for level A and any sub-WADs for the current phase that are not already loaded. Console 2 is now the level server (i.e., controlling machine) for level A and determines the change of phase for level A. In this example there are no level clients in level A because player P1 has left level A. However, if other players were to enter level A, they would be level clients of console 2.

As player P1 walks through corridor 608, console 1, upon which player P1 plays, loads the base WAD for level B and the sub-WADs for the current phase of level B, e.g., as determined from information in the base WAD. Console 1 becomes the controlling machine (level server) for level B as indicated in the key.

In FIG. 6C, player P1 moves from level B back to level A. Console 1 unloads the base WAD and sub-WADs for level B and dutifully requests to manage level A. However, because level A is already managed by console 2, console 1's request to manage level A is refused or otherwise denied. Level A remains managed by console 2, and console 1 becomes a level client of level A.

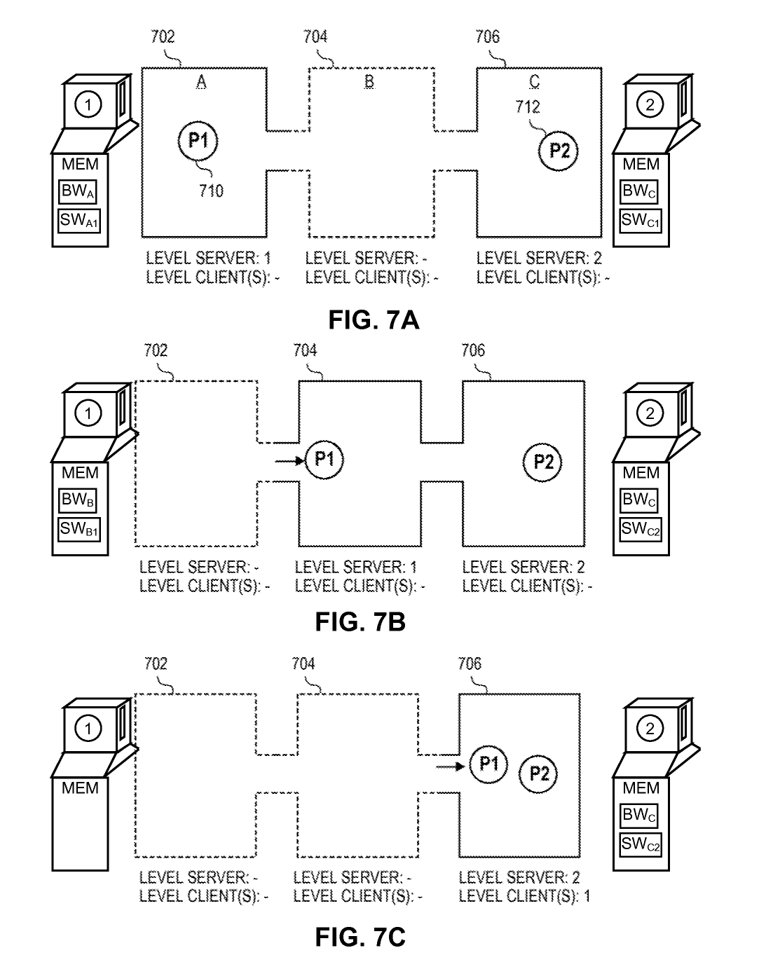

FIGS. 7A-7C illustrate a situation of an embodiment in which the players start out in different logical spaces 702, 704, and 706, which are referred to as levels A, B, and C, respectively. Players 710 and 712 are referred to as players P1 and P2, respectively.

In FIG. 7A, player P1 starts out in level A, and player P2 starts out in level C. Console 1, upon which player P1 plays, is the controlling machine of level A and thus manages the phases of level A. The base WAD for level A (BW_{A}) is stored in memory on Console 1 along with a set of sub-WADs (SW_{A1}) for the current phase (e.g., phase 1) of level A. Console 2, upon which player P2 plays, is the controlling machine of level C and thus manages the phases of level C. The base WAD for level A (BW_{C}) is stored in memory on Console 1 along with a set of sub-WADs (SW_{C1}) for the current phase (e.g., phase 1) of level C. Since neither player P1 nor player P2 is in Level B, the base WAD for Level B is not loaded on either Console 1 or Console 2.

In FIG. 7B, player P1 leaves level A after completing phase 1 and drops level server duties for level A. Console 1 unloads the base WAD for level A BW_{A} from memory. Console 1 also unloads the set of sub-WADs SW_{A1} for phase 1 of level A. P1 then enters level B. Console 1 loads the base WAD for Level B and the sub-WAD SW_{BC} for the current phase. Console 1 thus becomes the controlling machine of level B. During this time player P2 advances from phase 1 to phase 2 of level C and Console 2 accordingly loads the corresponding set of sub-WADs (SW_{C2}) for phase 2 into its memory.

In FIG. 7C, player P1 leaves level B in the middle of the current phase. Console 1 unloads the base WAD BW_{B} for level B from memory and also unloads the sub-WAD SW_{BC} for the current phase of level B. Player P1 then enters level C and console 1 requests to manage level C, but the request is denied because console 2 already has the base WAD BW_{C} for level C loaded into its memory and is managing level C in phase 2. Thus, console 2 continues to manage level C, as it had in FIGS. 7A-7B, and console 1 becomes a non-controlling machine of level C. Console 2 notifies console 1 of the current phase (phase 2 in this example) and provides console 1 with relevant data as needed from the base WAD BW_{C} for level C and the sub-WAD SW_{C2} for phase 2 of level C.

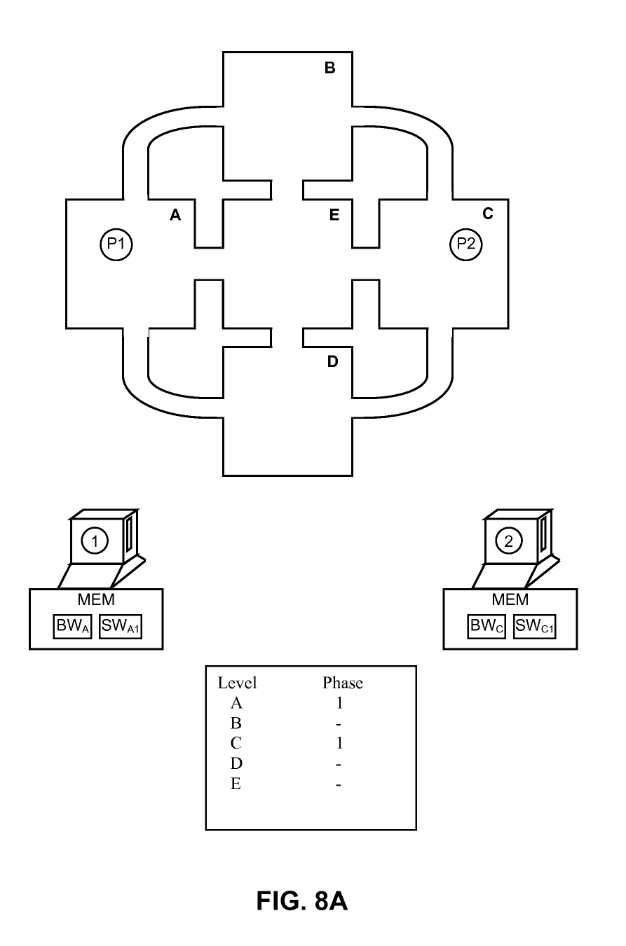

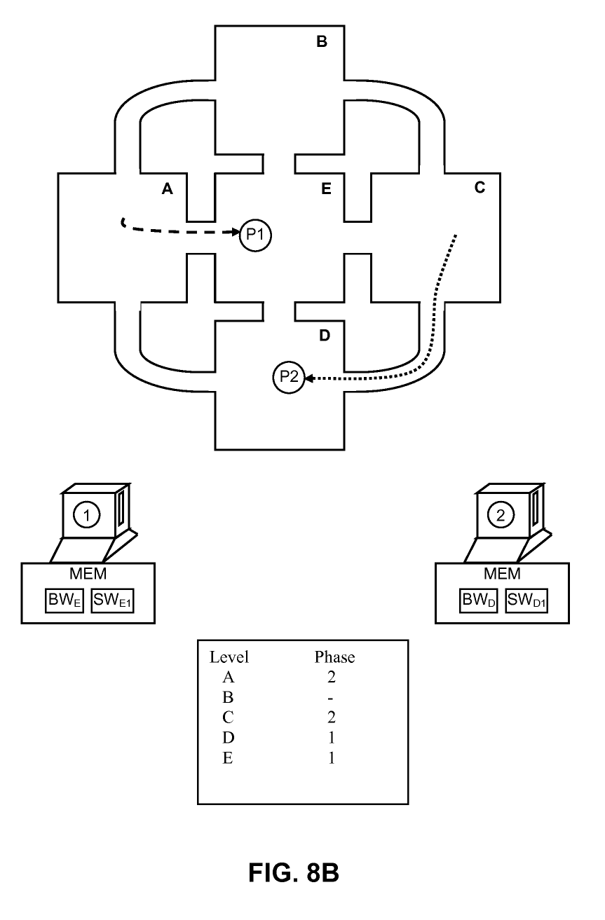

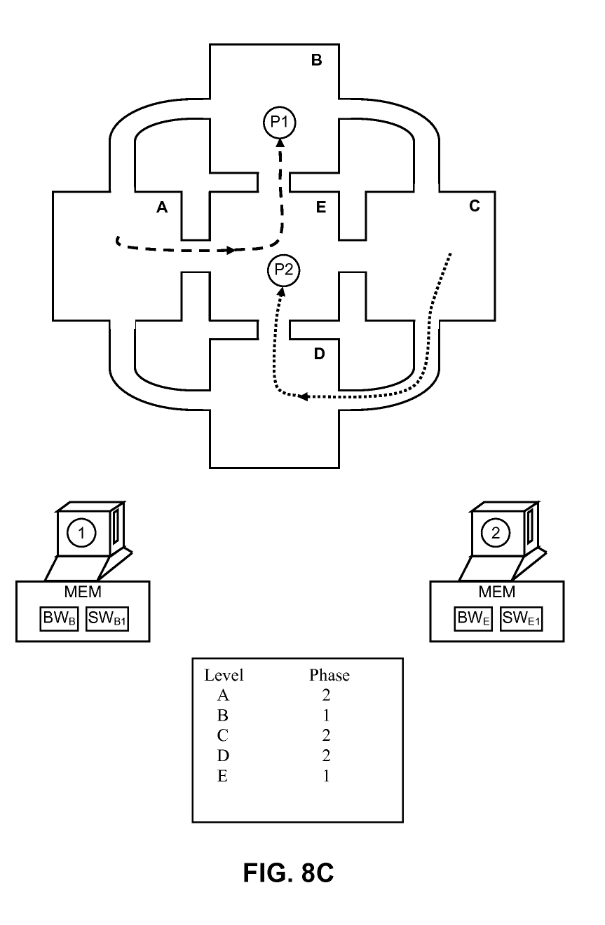

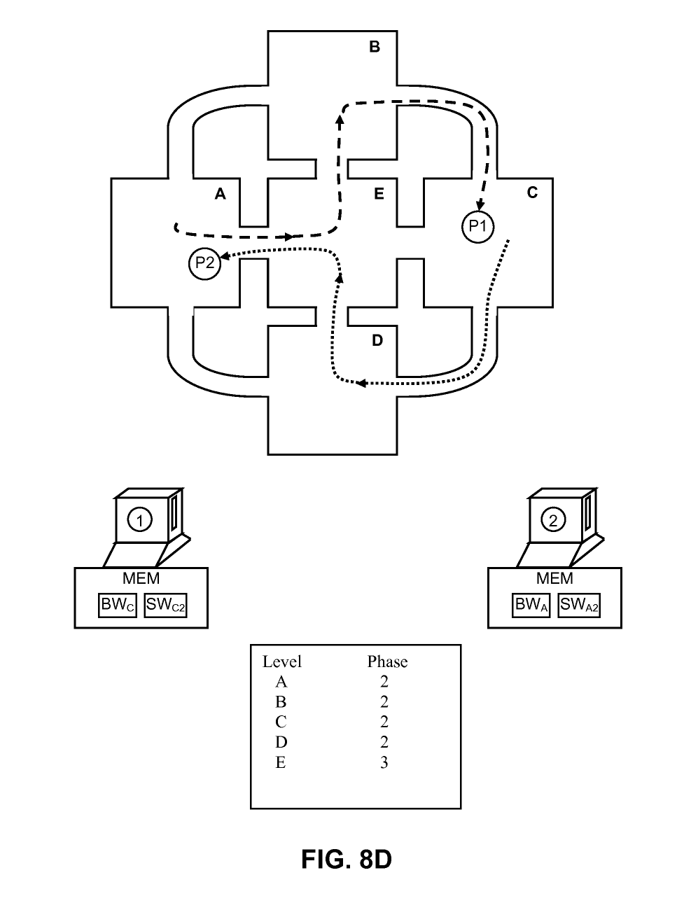

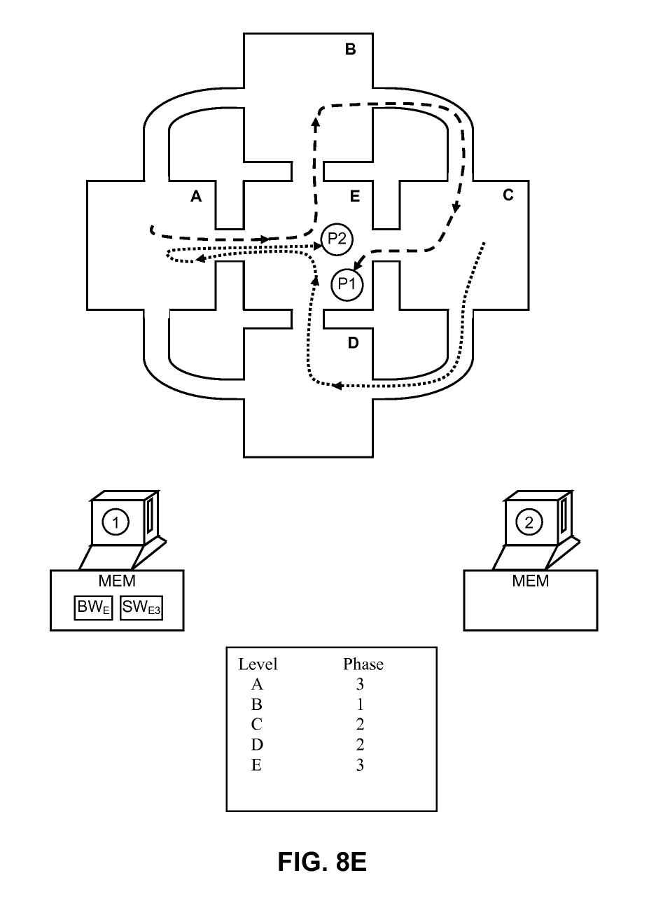

As noted above, embodiments of the invention allow synchronization of activity when players split up. By keeping track of the phase in each logical space, a player can resume activity in a given logical space at a point where another player has left off. An example of this is illustrated in FIGS. 8A-8E. In this example, there are five logical spaces labeled A, B, C, D, and E and two players labeled P1 and P2. Player 1 uses console 1 and player 2 uses console 2. The players can move among the logical spaces via corridors. For convenience, the logical spaces are referred to as levels. Initially, as shown in FIG. 8A, player P1 is in room A and player P2 is in room C at phase 1. The phases of levels A, B, C, D, and E are described in the table. Console 1 has the base WAD BW_{A} for room A and the sub-WAD set SW_{A1} for phase 1 of level A loaded in memory. Similarly, Console 2 has the base WAD BW_{C} for level C and the sub-WAD set SW_{C1} for phase 1 of room C loaded in memory.

As seen in FIG. 8B, player P1 has finished phase 1 of level A and begun phase 2. However, before finishing phase 2, player P2 moves from level A to level E. The base WAD BW_{A} for level A and the corresponding sub WAD set phase 2 of level A are unloaded and the base WAD for level E is loaded into the memory of console 1 along with the sub-WAD set SW_{E1} for phase 1 of level E. Similarly, player P2 has finished phase 1 of level C and begun phase 2. However, before finishing phase 2, player P2 moves from level C to level D. The base WAD BW_{C} for level C and the corresponding sub WAD set phase 2 of level C are unloaded and the base WAD for level D is loaded into the memory of console 2 along with the sub-WAD set SW_{D1} for phase 1 of level D.

Before finishing phase 1 of level E, player P1 moves from level E to level B, as shown in FIG. 8C. Console 1 unloads the base WAD BW_{E} for level E from memory and also unloads the sub-WAD set SW_{E1} for level E. Console 1 then loads the base WAD for level B and the sub-WAD set corresponding to phase 1 of level B. During this time, player 2 has finished phase 1 of level D and begun phase 2. The sub-WAD set for phase 2 of level D replaces the sub-WAD set for phase 1 of level D in console 2's memory. Console 2 then loads the base WAD BW_{E} for level E and determines that the current phase is phase 1, since player P1 was still in phase 1 when player P1 left level E. Player P2 can resume the activity in level E at the point that player P1 left off.

Player P1 finishes phase 1 of level B and begins phase 2. The sub-WAD set for phase 2 replaces the sub-WAD set SW_{B1} for phase 1. However, as shown in FIG. 8D, before completing phase 2 of level B, player P1 moves to level C, which had player P2 had left while in phase 2 of level C. Console 1 unloads the base WAD BW_{B} for level B and the sub-WAD set for phase 2 of level B and loads the base WAD for level C. Since player P2 had left level C in phase 2, console 1 determines (e.g., from information in the level B base WAD BW_{B}) that the current phase for level C is phase 2. Console 1 therefore loads the sub-WAD set SW_{C2} for phase 2 of level C into memory.

During this time, player P2 has completed phase 1 and phase 2 of level E and begun phase 3. The sub-WAD set for phase 3 replaces the sub-WAD set for phase 2 of level E. Before completing phase 3 of level E, player P2 moves to level A, as seen in FIG. 8D. Recall that player P1 had left level A in phase 2, as indicated by the table in FIG. 8D. Console 1 unloads the base WAD BW_{E} for level E and the sub-WAD set for phase 3 of level E and loads the base WAD for level A. Since player P1 had left level A in phase 2, console 2 determines (e.g., from information in the level A base WAD BW_{A}) that the current phase for level A is phase 2. Console 2 therefore loads the sub-WAD set SW_{A2} for phase 2 of level A into memory.

Player P2 completes phase 2 of level A and begins phase 3. Console 2 loads the sub-WAD set for phase 3 of level A and may unload any sub-WADs for phase 2 that are not needed. Meanwhile, before completing phase 2 of level C, player P1 moves to level E. Since level E is unoccupied when player P1 enters it, console 1 becomes the controlling machine for level E. Console 1 loads the base WAD BW_{E} for level E into memory and determines that the current phase for level E is phase 3, since that was the last phase player P2 was in when player P2 left level E. Console 1 therefore loads the sub-WAD set SW_{E3} for phase 3 of level E and activity can proceed in level E from the point player P2 left off.

At this point player P2 leaves level A before completing phase 3 of level A. Console 2 unloads the base WAD for level A and the sub-WAD set for phase 3 of level A. Player P2 then enters level E, which is already occupied by player P1. This is the situation illustrated in FIG. 8E. Since console 1 is the controlling machine for level E, console 2 does not load the base WAD BW_{E} for level E. Console 2 is a non-controlling machine for level E and activity in level E is managed by console 1. Console 1 may notify console 2 that the current phase of activity in level E is phase 3 and may provide console 2 with relevant information from sub-WAD SW_{E3} so that player P1 and player P2 are in sync in phase 3 of level E.

In the examples described above, other players can be involved in the various levels. Each respective game console may request to become a controlling machine for a given logical space as it is entered. If the logical space does not already have a controlling machine, then the request may be granted and the relevant base WAD for the logical space and the relevant sub-WAD set for the appropriate phase may be loaded. If the logical space already has a controlling machine then the request is denied and the player's console becomes a non-controlling machine and follows the phase determined by the controlling machine.

Although examples are described in which the controlling machine is that of the first user to enter a logical space, alternative arrangements for determining which machine is the controlling machine and which machines are non-controlling can include making the machine with the best connection, the fastest speed, or the most memory the controlling machine. In some embodiments, a server or host player's machine may determine which machine is the controlling machine for all logical spaces. The ‘host player’ may be the first player to start the game, with which other players join in as guests. If the host player drops out, then the second player to start the game may become the host player, and so on.

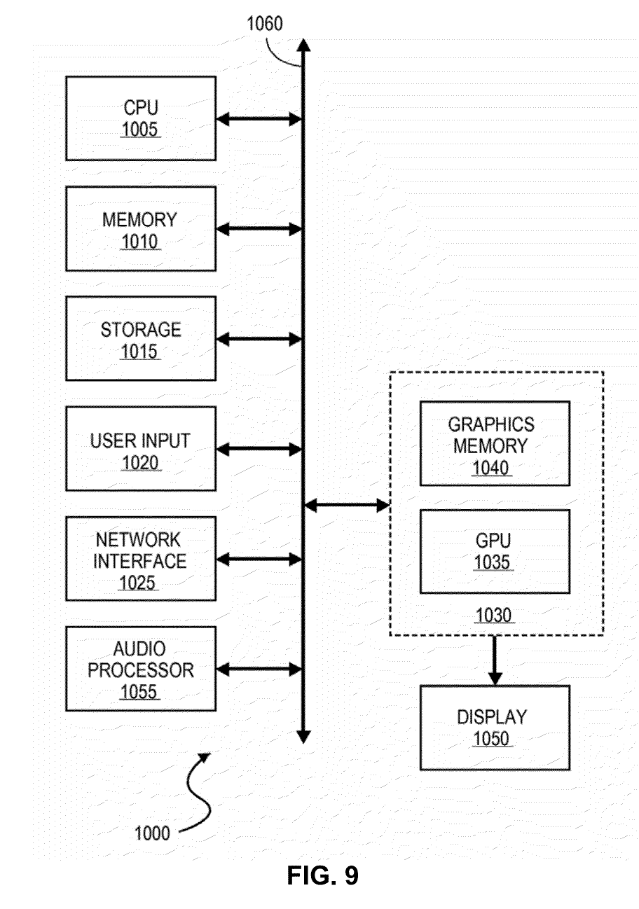

FIG. 9 illustrates an example computer system suitable for use with embodiments of the present invention. The figure is a block diagram of a computer system 1000, such as a personal computer, video game console, personal digital assistant, or other digital device, suitable for practicing an embodiment of the invention. Computer system 1000 includes a central processing unit (CPU) 1005 for running software applications and optionally an operating system. CPU 1005 may include one or more homogeneous or heterogeneous processing cores.

A memory 1010 stores applications and data for use by the CPU 1005. Such data may include base WADs and sub-WADs. Applications may include coded instructions configured to implement data management methods described herein, such as the method 100 depicted in FIG. 1.

A storage device 1015 provides nonvolatile storage for applications and data and may include fixed disk drives, removable disk drives, flash memory devices, and CD-ROM, DVD-ROM, Blu-ray, HD-DVD, or other optical storage devices. The storage device 1015 may be used to store base WADs and sub-WADs for subsequent loading into the memory 1010. Base WADs and sub-WADs that are unloaded from memory 1010 may also be stored in the storage device 1015 so that the most recent state of assets defined by the data in the base WADs and sub-WADs may be preserved.

User input devices 1020 communicate user inputs from one or more users to the computer system 1000, examples of which may include keyboards, mice, joysticks, touch pads, touch screens, still or video cameras, and/or microphones.

Network interface 1025 allows computer system 1000 to communicate with other computer systems via an electronic communications network, and may include wired or wireless communication over local area networks and wide area networks such as the Internet. Base WADs and sub-WADs may be loaded from a remote location over a network via the network interface 1025. Similarly, base WADs and sub-WADs may be unloaded for storage at a remote location over a network via the network interface 1025.

An audio processor 1055 may be adapted to generate analog or digital audio output from instructions and/or data provided by the CPU 1005, memory 1010, and/or storage 1015. The components of computer system 1000, including CPU 1005, memory 1010, data storage 1015, user input devices 1020, network interface 1025, and audio processor 1055 are connected via one or more data buses 1060.

A graphics subsystem 1030 may be further connected with data bus 1060 and the components of the computer system 1000. The graphics subsystem 1030 may include a graphics processing unit (GPU) 1035 and a graphics memory 1040. Graphics memory 1040 includes a display memory (e.g., a frame buffer) used for storing pixel data for each pixel of an output image. The graphics memory 1040 can be integrated in the same device as GPU 1035, connected as a separate device with GPU 1035, and/or implemented within memory 1010. Pixel data can be provided to graphics memory 1040 directly from the CPU 1005. Alternatively, the CPU 1005 may provide the GPU 1035 with data and/or instructions defining the desired output images, from which the GPU 1035 generates the pixel data of one or more output images. The data and/or instructions defining the desired output images can be stored in the memory 1010 and/or the graphics memory 1040. In an embodiment, the GPU 1035 may include 3D rendering capabilities for generating pixel data for output images from instructions and data defining the geometry, lighting, shading, texturing, motion, and/or camera parameters for a scene. The GPU 1035 can further include one or more programmable execution units capable of executing shader programs.

The graphics subsystem 1030 may periodically output pixel data for an image from the graphics memory 1040 to be displayed on a display device 1050, e.g., as text, symbols, two-dimensional images or three-dimensional images. The display device 1050 may be any device capable of displaying visual information in response to a signal from the computer system 1000, including CRT, LCD, plasma, and OLED displays. Computer system 1000 can provide the display device 1050 with an analog or digital signal.

In embodiments of the invention, CPU 1005 is one or more general-purpose microprocessors having one or more processing cores. Further embodiments of the invention can be implemented using one or more CPUs with microprocessor architectures specifically adapted for highly parallel and computationally intensive applications, such as media and interactive entertainment applications.

Further embodiments can be envisioned to one of ordinary skill in the art from the specification and figures. In other embodiments, combinations or sub-combinations of the above-disclosed invention can be advantageously made. The block diagrams of the architecture and flow charts are grouped for ease of understanding. However it should be understood that combinations of blocks, additions of new blocks, re-arrangement of blocks, and the like are contemplated in alternative embodiments of the present invention.

The specification and drawings are, accordingly, to be regarded in an illustrative rather than a restrictive sense. It will, however, be evident that various modifications and changes may be made thereunto without departing from the broader spirit and scope of the invention as set forth in the claims.

While the above is a complete description of the preferred embodiment of the present invention, it is possible to use various alternatives, modifications, and equivalents. Therefore, the scope of the present invention should be determined not with reference to the above description, but should, instead be determined with reference to the appended claims, along with their full scope of equivalents. Any feature described herein, whether preferred or not, may be combined with any other feature described herein, whether preferred or not. IN the claims that follow, the indefinite article “A” or “An” refers to a quantity of one or more of the item following the article, except where expressly stated otherwise. The appended claims are not to be interpreted as including means-plus-function limitations, unless such a limitation is explicitly received in a given claim using the phrase “means for.”

What is claimed is:

1. A method for data management in a computer system having a processor and a memory, comprising:
a) with the computer system, loading into the memory a base WAD corresponding to a logical space associated with a computer application being run by the processor, wherein the base WAD contains a set of data that is uniquely associated with the logical space, wherein there are zero or more phases of activity taking place in the logical space during running of the computer application, wherein the zero or more phases are uniquely associated with the base WAD, wherein the set of data in the base-WAD remains loaded for each of the zero or more phases;
b) with the computer system, for each phase of the zero or more phases, loading a different set of zero or more sub-WADs into the memory, whereby there are zero or more sets of sub-WADs, wherein each sub-WAD contains data that is associated with a corresponding phase of the zero or more phases; and
c) with the computer system, managing the activity for a given phase of the zero or more phases using the common data in the base WAD and the sets of data in the sets of zero or more sub-WADs corresponding to the given phase,
wherein each phase has a corresponding set of zero or more sub-wads, wherein the computer system is configured to communicate with one or more other computer systems that can access the logical space and wherein the computer system is configured to act as a controlling machine for the logical space, wherein the controlling machine exclusively controls changes of phase among the zero or more phases.

2. The method of claim 1, further comprising, with the computer system, wherein the zero or more phases include two or more phases, the method further comprising unloading one or more sub-WADs associated with a previous phase of the two or more phases that are not needed for a current or subsequent phase of the two or more phases.

3. The method of claim 2, wherein unloading the one or more sub-WADs that are not needed for the current phase or subsequent phase includes saving a current state for one or more assets associated with the one or more sub-WADs that are not needed.

4. The method of claim 1, wherein the logical space is one of a plurality of related logical spaces, wherein each other logical space in the plurality has associated with it a base WAD, whereby there are a plurality of base WADs, zero or more phases and one or more corresponding sets of sub-WADs.

5. The method of claim 4, wherein each sub-WAD associated with a given base WAD is not shared with any other base WAD.

6. The method of claim 4, wherein each base WAD in the plurality has the same non-zero finite number of phases associated with.

7. The method of claim 6, wherein, for one or more phases for one or more base-WADs of the plurality a corresponding set of sub-WADs is an empty set.

8. The method of claim 7, wherein, for one or more other phases for the one or more base-WADs of the plurality a corresponding set of sub-WADs is a non-empty set.

9. The method of claim 1, wherein the computer application is a video game application.

10. The method of claim 9, wherein the logical space is a level within the video game.

11. The method of claim 9, wherein the logical space is a virtual location within the video game.

12. The method of claim 1, further comprising unloading the base WAD from the memory.

13. The method of claim 12, wherein unloading the base WAD includes saving a current phase of zero or more phases.

14. The method of claim 1, wherein the computer system is connected to one or more other computer systems in a peer-to-peer network.

15. The method of claim 14, wherein the base WAD associated with the logical space is not loaded into a memory for any of the one or more other computer systems.

16. The method of claim 14, wherein the one or more other computer systems follow the phase determined by the computer system.

17. The method of claim 14, wherein a different one of the one or more other computer systems includes a memory into which a base WAD for a different logical space is loaded and wherein the different one of the one or more other computer systems is configured to act as a controlling machine for the different logical space.

18. A computer system, comprising:
a processor;
a memory; and
one or more computer executable instructions stored in the memory and executable by the processor, wherein the instructions are configured to implement a method for data management in the computer system when executed by the processor, the method comprising:
a) loading into the memory a base WAD corresponding to a logical space associated with a computer application being run by the processor, wherein the base WAD contains a set of data that is uniquely associated with the logical space, wherein there are zero or more phases of activity taking place in the logical space during running of the computer application, wherein the zero or more phases are uniquely associated with the base WAD, wherein the set of data in the base-WAD remains loaded for each of the zero or more phases;
b) for each phase of the zero or more phases, loading a different set of one or more sub-WADs into the memory, whereby there are one or more sets of sub-WADs, wherein each sub-WAD contains data that is associated with a corresponding phase of the zero or more phases; and
c) managing the activity for a given phase of the zero or more phases using the common data in the base WAD and the sets of data in the sets of zero or more sub-WADS corresponding to the given phase,
wherein each phase has a corresponding set of zero or more sub-wads,
wherein the computer system is configured to communicate with one or more other computer systems that can access the logical space and wherein the computer system is configured to exclusively control changes of phase among the zero or more phases.

19. A non-transitory computer readable medium having computer-executable instructions embodied therein, the computer-executable instructions being configured to implement a method for data management in a computer system having a processor and a memory, the method comprising:
a) with the computer system, loading into the memory a base WAD corresponding to a logical space associated with a computer application being run by the processor, wherein the base WAD contains a set of data that is uniquely associated with the logical space, wherein there are zero or more phases of activity taking place in the logical space during running of the computer application, wherein the zero or more phases are uniquely associated with the base WAD, wherein the set of data in the base-WAD remains loaded for each of the zero or more phases;
b) with the computer system, for each phase of the zero or more phases, loading a different set of zero or more sub-WADs into the memory, whereby there are zero or more sets of sub-WADs, wherein each sub-WAD contains data that is associated with a corresponding phase of the zero or more phases; and
c) with the computer system, managing the activity for a given phase of the zero or more phases using the common data in the base WAD and the sets of data in the sets of zero or more sub-WADs corresponding to the given phase,
wherein each phase has a different corresponding set of zero or more sub-wads,
wherein the computer system is configured to communicate with one or more other computer systems that can access the logical space and wherein the computer system is configured to exclusively control changes of phase among the zero or more phases.
